(19) United States
(12) Patent Application Publication
(10) Pub. No.: US 2026/0181117 A1
(43) Pub. Date: Jun. 25, 2026

(54) METHOD AND APPARATUS FOR GENERATING MULTI-VIEW VIDEO

(71) Applicant: Beijing Co Wheels Technology Co., Ltd., Beijing (CN)

(72) Inventors: Hengtong HU, Beijing (CN); Junpeng JIANG, Beijing (CN); Gangyi HONG, Beijing (CN); Xia ZHOU, Beijing (CN); Jie XIANG, Beijing (CN); Xueyang ZHANG, Beijing (CN); Kun ZHAN, Beijing (CN); Peng JIA, Beijing (CN)

(21) Appl. No.: 19/098,158

(22) Filed: Apr. 2, 2025

(30) Foreign Application Priority Data
Dec. 25, 2024 (CN) 202411936907.9
Feb. 24, 2025 (CN) 202510208167.5

(51) Int. Cl. H04N 13/111; G06V 10/774; G06V 20/70

(52) U.S. Cl. CPC H04N 13/111; G06V 10/774; G06V 20/70

(57) ABSTRACT

The present application discloses a method and an apparatus for generating a multi-view video, which relate to the field of artificial intelligence. At least one image with at least one view is generated by using at least one BEV image through a generative model, thereby achieving the purpose of generating videos with different views.

### CROSS-REFERENCE TO RELATED APPLICATIONS

The present application is based upon and claims priority to Chinese Patent Application No. 202510208167.5, filed on Feb. 24, 2025, which claims priority of Chinese Application No. 202411936907.9, filed on Dec. 25, 2024. Chinese Patent Application No. 202510208167.5 and Chinese Application No. 202411936907.9 are hereby incorporated by reference in their entirety.

### BACKGROUND

In the field of autonomous driving, generating high-fidelity, temporally consistent videos is critical to simulating, testing and training the autonomous driving system. In the related art, the view of the generated video is single.

### SUMMARY

The present disclosure relates to the technical field of artificial intelligence, in particular to a method and an apparatus for generating a multi-view video.

In view of the above problems, the present disclosure provides a method and an apparatus for generating a multi-view video. The specific solutions are as follows.

In the first aspect of the present disclosure, a method for generating a multi-view video is provided. The method includes the following operation.

At least one image with at least one view is generated by using at least one Bird's Eye View (BEV) image through a generative model.

In the second aspect of the present disclosure, an apparatus for generating a multi-view video is provided. The apparatus includes a processor and a memory connected with the processor.

The memory is configured to store a computer program, and the processor is configured to execute the computer program to cause the apparatus to: generate, through a generative model, at least one image with at least one view by using at least one BEV image.

In the third aspect of the present disclosure, a computer storage medium is provided. The storage medium carries one or more computer programs. When the one or more computer programs are executed by an electronic device, the electronic device generates, through a generative model, at least one image with at least one view by using at least one BEV image.

### BRIEF DESCRIPTION OF THE DRAWINGS

The above and other features, advantages, and aspects of embodiments of the present disclosure will become more apparent when taken in combination with the accompanying drawings and with reference to the following detailed embodiments. Throughout the drawings, the same or similar reference numerals denote the same or similar elements. It should be understood that the drawings are schematic and components and elements are not necessarily drawn to scale.

FIG. 1 is a schematic diagram of a system architecture provided by the present disclosure.

FIG. 2 is a schematic diagram of an optional hardware structure of the terminal 100 provided by the present disclosure.

FIG. 3 is a schematic structural diagram of a server 200 provided by the present disclosure.

FIG. 4 is a schematic flowchart of a method for generating a multi-view video provided by the present disclosure.

FIG. 5 is a schematic diagram of an implementation manner of a generative model provided by the present disclosure.

FIG. 6 is a qualitative comparison diagram of videos respectively corresponding to multiple views generated by the MagicDrive and the generative model provided by the present disclosure.

FIG. 7 is a schematic diagram of the use-case of scene editing provided by the present disclosure.

FIG. 8 is a schematic flowchart of another implementation manner of a method for generating a multi-view video provided by the present disclosure.

FIG. 9 is a schematic structural diagram of an apparatus for generating a multi-view video provided by the present disclosure.

FIG. 10 is a schematic structural diagram of another implementation manner of an apparatus for generating a multi-view video provided by the present disclosure.

FIG. 11 is a schematic structural diagram of an electronic device provided by the present disclosure.

### DETAILED DESCRIPTION

Hereinafter, embodiments of the present disclosure will be described with reference to the accompanying drawings in the embodiments of the present disclosure. The terminology used in the embodiments of the present disclosure is only for the purpose of explanation of specific embodiments of the present disclosure, and is not intended to limit the present disclosure.

Hereinafter, embodiments of the present disclosure will be described with reference to the accompanying drawings. Those skilled in the art will know that with the development of technology and the emergence of new scenes, the technical solutions provided by the embodiments of the present disclosure are equally applicable to similar technical problems.

The terms “first”, “second” and the like in the description and claims of the present disclosure and the above drawings are used to distinguish similar objects, and are not necessarily used to describe a specific order or sequence. It should be understood that the terms so used are interchangeable where appropriate, and this is merely a way of distinguishing objects with the same attribute in the description of embodiments of the present disclosure. Furthermore, the terms “including” and “having” and any variations thereof are intended to cover non-exclusive inclusion so that a process, method, system, product, or apparatus comprising a series of units is not necessarily limited to those units, but may include other units not explicitly listed or inherent to the process, method, products, or apparatus.

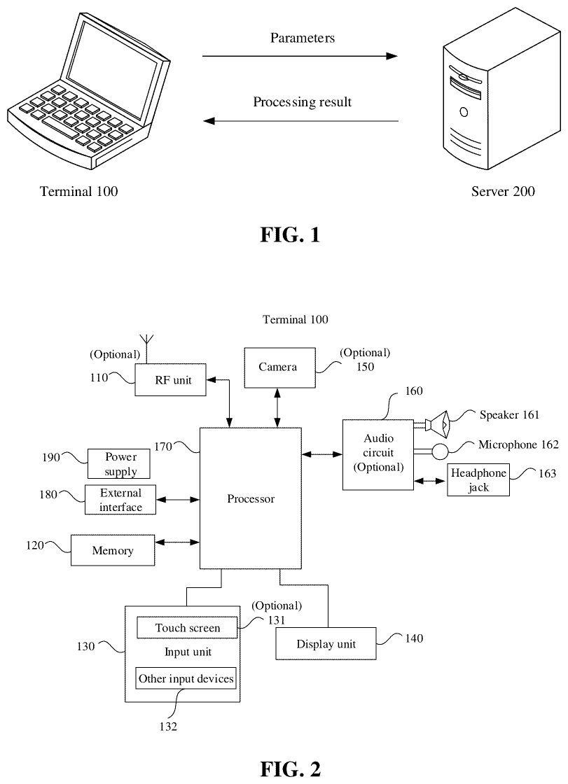

Referring to FIG. 1, a schematic diagram of a system architecture is illustrated. The system may include a terminal 100 and a server 200. The server 200 may include one or more servers (one server is described as an example in FIG. 1), and the server 200 may provide the method provided by the embodiment of the present disclosure to one or more terminals.

An application program or a web page may be installed on the terminal 100, and the application program and the web page may provide an interface. The terminal 100 may receive relevant parameters, such as the first video, input by the user on the interface, and send the above parameters to the server 200. The server 200 may obtain a processing result based on the received parameters, and return the processing result to the terminal 100.

It should be understood that in some optional implementations, the terminal 100 may complete the operation of obtaining the processing result based on the received parameters by itself without the cooperation of the server, which is not limited in the embodiments of the present disclosure.

Next, the product form of the terminal 100 in FIG. 1 will be described.

The terminal 100 in the embodiments of the present disclosure may be a mobile phone, a tablet computer, a wearable device, a vehicle-mounted device, an augmented reality (AR)/virtual reality (VR) device, a notebook computer, an ultra-mobile personal computer (UMPC), a netbook, a personal digital assistant (PDA), or the like, which is not limited in the embodiments of the present disclosure.

FIG. 2 illustrates a schematic diagram of an optional hardware structure of the terminal 100.

Referring to FIG. 2, the terminal 100 may include components such as a radio frequency (RF) unit 110, a memory 120, an input unit 130, a display unit 140, a camera 150 (optional), an audio circuit 160 (optional), a speaker 161 (optional), a microphone 162 (optional), a headphone jack 163 (optional), a processor 170, an external interface 180, and a power supply 190. Those skilled in the art will understand that FIG. 2 is merely an example of a terminal, and does not constitute a limitation of the terminal. The terminal may include more or fewer components than the illustrated components, or certain components may be combined, or the terminal may include different components.

The input unit 130 may be configured to receive input numeric or character information and generate key signal input related to user settings and function control of the terminal. Specifically, the input unit 130 may include a touch screen 131 (optional) and/or other input devices 132. The touch screen 131 may collect a touch operation of the user on or near the touch screen (such as an operation of the user on or near the touch screen using any suitable object such as a finger, a joint, a stylus, etc.), and drive the corresponding connection device according to a preset program. The touch screen may detect the touch action of the user on the touch screen, convert the touch action into a touch signal and send the touch signal to the processor 170, and can receive and execute the command sent by the processor 170. The touch signal includes at least contact coordinate information. The touch screen 131 may provide an input interface and an output interface between the terminal 100 and the user. In addition, the touch screen may be realized by various types such as resistive type, capacitive type, infrared type, and surface acoustic wave. In addition to the touch screen 131, the input unit 130 may include other input devices. Specifically, the other input device 132 may include, but is not limited to, one or more of a physical keyboard, a function key (such as a volume control key, a switch key, or the like), a trackball, a mouse, a joystick, or the like.

The input device 132 may receive input data or the like.

The display unit 140 may be configured to display information input by or provided to the user, various menus of the terminal 100, an interactive interface, file display, and/or playback of any kind of multimedia file. In the embodiments of the present disclosure, the display unit 140 may be used to display an interface, a processing result, and the like.

The memory 120 may be configured to store instructions and data, and the memory 120 may mainly include a storage instruction area and a storage data area. The storage data area may store various data, such as multimedia files, text, etc. The storage instruction area may store software elements such as an operating system, an application, instructions required for at least one function, or a subset or extended set thereof. A non-volatile random access memory may also be included. The memory 120 is also configured to provide hardware, software, and data resources in management computing processing devices, supporting control software and applications to the processor 170. The processor is also configured to store multimedia files, running programs and applications.

The processor 170 is a control center of the terminal 100, connects various parts of the entire terminal 100 using various interfaces and lines, performs various functions of the terminal 100 and processes data by running or executing instructions stored in the memory 120 and invoking data stored in the memory 120, thereby performing overall control of the terminal device. Optionally, the processor 170 may include one or more processing units. Preferably, the processor 170 may integrate an application processor and a modem processor. The application processor mainly handles an operating system, a user interface, an application program, and the like, and the modem processor mainly handles wireless communication. It should be understood that the above modem processor may not be integrated into the processor 170. In some embodiments, the processor and the memory may be implemented on a single chip. In some embodiments, the processor and the memory may be implemented separately on independent chips. The processor 170 may also be used to generate corresponding operation control signals, send the signals to corresponding components of the computing processing device, read and process data in the software, especially data and programs in the memory 120, so as to cause each functional module therein to perform corresponding functions to control the corresponding components to act according to the requirements of the instructions.

Here, the memory 120 may be configured to store software code related to the method for generating the multi-view video, the processor 170 may perform the operation of the method for generating the multi-view video, or may schedule other units (such as the input unit 130 and the display unit 140 described above) to implement corresponding functions.

The RF unit 110 (optional) may be configured to receive and send information, or receive and send signals during a call, for example, after receiving downlink information of the base station, to cause the processor 170 to process the downlink information. Further, the RF unit 110 is configured to send the designed uplink data to the base station. Generally, the RF circuit includes, but is not limited to, an antenna, at least one amplifier, a transceiver, a coupler, a Low Noise Amplifier (LNA), a duplexer, and the like. In addition, the RF unit 110 may also communicate with network devices and other devices through wireless communication. The wireless communication may use any communication standard or protocol, including but not limited to the Global System of Mobile communication (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

Here, in the embodiments of the present disclosure, the RF unit 110 may send data to the server 200 and receive the processing result sent by the server 200.

It should be understood that the RF unit 110 is optional, which may be replaced with another communication interface, such as a network port.

The terminal 100 may further include a power supply 190 (such as a battery) that supplies power to various components. Preferably, the power supply may be logically connected with the processor 170 through a power management system, so that functions such as management of charging and discharging, and power consumption management are realized through the power management system.

The terminal 100 further includes an external interface 180, which may be a standard Micro USB interface, a multi-pin connector, and may be configured to connect other devices to communicate with the terminal 100, or may be configured to connect a charger to charge the terminal 100.

Although not illustrated, the terminal 100 may further include a flash lamp, a wireless fidelity (WiFi) module, a Bluetooth module, sensors of different functions, and the like, which will not be repeatedly described herein. Part or all of the methods described below may be applied to the terminal 100 as illustrated in FIG. 2.

Next, the product form of the server 200 in FIG. 1 will be described.

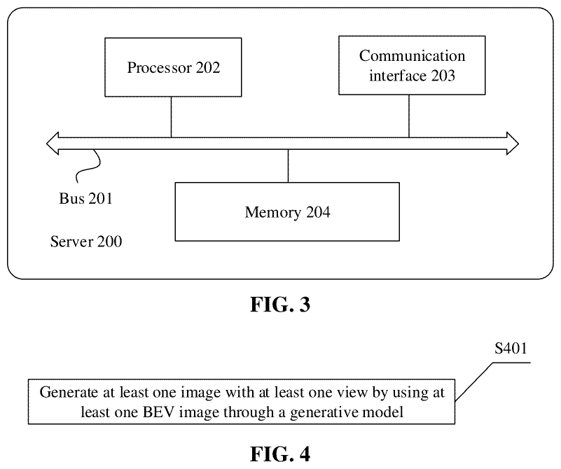

FIG. 3 provides a schematic structural diagram of a server 200. As illustrated in FIG. 3, the server 200 includes a bus 201, a processor 202, a communication interface 203, and a memory 204. The processor 202, the memory 204, and the communication interface 203 communicate through the bus 201.

The bus 201 may be a peripheral component interconnect (PCI) bus, an extended industry standard architecture (EISA) bus, or the like. The bus may be classified into address bus, data bus, control bus, etc. For ease of representation, only one thick line is illustrated in FIG. 3, but it does not indicate that there is only one bus or one type of bus.

The processor 202 may be any one or more of processors such as a central processing unit (CPU), a graphics processing unit (GPU), a microprocessor (MP), or a digital signal processor (DSP).

The memory 204 may include a volatile memory, such as a random access memory (RAM). The memory 204 may also include a non-volatile memory, such as a read-only memory (ROM), a flash memory, a hard disk drive (HDD), or a solid state drive (SSD).

The memory 204 may be configured to store software code related to the method for generating the multi-view video, and the processor 202 may perform the operations of the method for generating the multi-view video in the chip, or may schedule other units to implement corresponding functions.

It should be understood that the above terminal 100 and the server 200 may be centralized or distributed devices, and the processors (e.g., processor 170 and processor 202) in the terminal 100 and server 200 may be hardware circuits (e.g., application specific integrated circuits (ASICs), field-programmable gate arrays (FPGAs)), general-purpose processors, digital signal processing (DSP), microprocessors or microcontrollers, etc., or combinations of these hardware circuits. For example, the processor may be a hardware system that has the function of executing instructions, such as CPU, DSP, etc., or a hardware system that does not have the function of executing instructions, such as ASIC, FPGA, etc., or a combination of the hardware system that does not have the function of executing instructions and the hardware system that has the function of executing instructions.

Generating high-fidelity, temporally consistent videos in autonomous driving scenarios faces a significant challenge, e.g. problematic maneuvers in corner cases. Despite recent video generative models built on top of Diffusion Transformers (DiT) is proposed to slove this problem, works are still missing which are targeted on exploring the potential for multi-view videos generation scenarios. Noticeably, the present disclosure proposes the first DiT based framework specifically designed for generating temporally and multi-view consistent videos which precisely match the given BEV layouts control. Specifically, the proposed framework leverages a parameter-free spatial view-inflated attention mechanism to guarantee the cross-view consistency, where joint cross-attention modules and ControlNet-Transformer are integrated to further improve the precision of control. To demonstrate advantages of the present disclosure, extensive qualitative comparisons on nuScenes dataset, particularly in some most challenging corner cases, are performed in the present disclosure. In summary, the effectiveness of the method proposed in the present disclosure in producing long, controllable and highly consistent videos under difficult conditions is proven to be effective.

BEV perception has gained significant attention for autonomous driving, highlighting its immense potential in tasks such as 3D object detection. Recent approaches like StreamPETR utilize multi-view videos for training, emphasizing the need for extensive, well-annotated datasets. However, gathering and annotating such data across diverse conditions is challenging and costly. To address the mentioned challenges, recent advancements in generative models show that synthetic data can effectively improve performance in various tasks like object detection and semantic segmentation. As the involvement of temporal data in video plays a crucial role in relative perception tasks, focus in the present disclosure shift to generating high-quality realistic videos. Achieving real-world fidelity requires high visual quality, cross-view and temporal consistency, and precise controllability. Notice that the potential of recent methods are limited due to disadvantages in including low resolution, fixed aspect ratios, and inconsistencies in object shape and color. Inspired by the success of Sora's performance in task of generating high-quality, temporally consistent videos, the present disclosure adapts the Diffusion Transformer (DiT) for controllable multi-view video generation in the work of the present disclosure. The proposed framework in the present disclosure is among the first few works which propose to use DiT for video generation in driving scenarios, enabling precise content control by integrating BEV layouts and scene text. Building on top of OpenSora architecture, the method in the present disclosure embeds joint cross-attention modules to manage the scene text and instance layouts from BEV images. Extending the ControlNet-Transformer approach for road sketches, the present disclosure ensures multi-view consistency with parameter-free spatial view-inflated attention. For the aim of supporting multi-resolution generation, faster inference, and various video length, the present disclosure utilizes OpenSora's training strategy and introduces a novel classifier-free guidance technique to enhance control and video quality.

In order to solve the above problems, the embodiments of the present disclosure provide a method for generating a multi-view video. Hereinafter, the method for generating a multi-view video according to the embodiments of the present disclosure will be described in detail with reference to the drawings.

Referring to FIG. 4, a schematic flowchart of a method for generating a multi-view video provided by an embodiment of the present disclosure is illustrated. As illustrated in FIG. 4, the method for generating a multi-view video provided by an embodiment of the present disclosure may include the operation S401. The operation S401 is described in detail below.

In operation S401, at least one image with at least one view is generated by using at least one BEV through a generative model.

The present disclosure provides a method for generating a multi-view video. At least one image with at least one view can be generated by using at least one BEV through a generative model, thereby achieving the purpose of generating videos with different views.

Exemplarily, the video corresponding to each view may include one or more images.

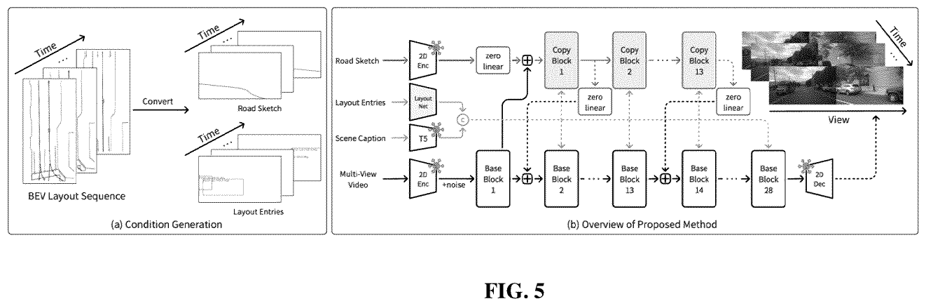

FIG. 5 illustrates a schematic diagram of an implementation manner of a generative model provided by an embodiment of the present disclosure.

The structural implementation with each individual component in the method proposed the present disclosure is illustrated in FIG. 5.

The overall architecture of the generative model is illustrated in FIG. 5. The parametric model proposed by OpenSora 1.1 is adopted as the baseline model. To achieve precise control over foreground and background information, The present disclosure incorporates layout entries and road sketches, derived from 3D geometric data through projection, into the process of layout conditioned video generation. The novel modules and training strategies proposed in the present disclosure will be introduced in the following sections.

Multi-Conditioned Spatial-Temporal DiT. Following OpenSora 1.1, the present disclosure utilizes a pre-trained and frozen Variational Autoencoder (VAE) from LDM to extract latent features zϵR^{V×T×4×h×w}, where V represents the number of views, T denotes the sequence length of frames, h and w denote the height and width of the latent features, respectively. These features are then modeled for spatiotemporal information using a 3D patch embedded. The textual input is encoded into 200 tokens using the T5 language model.

Spatial View-Inflated Attention. To guarantee the multi-view consistency during generation, the present disclosure replaces the commonly used cross-view attention modules with parameter-free view-inflated attention mechanism. Specifically, the present disclosure extends 2D spatial self-attention to enable cross-view interactions by reshaping the input from B×V×T×H′×W′×C to B×T×(V H′ W′)×C and treating VH′W′ as the sequence length. Consequently, the approach proposed in the present disclosure improves the multi-view coherence without compensating with additional parameters.

Caption-Layout Joint Cross-Attention. Following MagicDrive, the present disclosure uses a cross-attention mechanism to integrate scene captions and layout entries. The layout entries, i.e. instance details such as 2D coordinates, heading and ID, are Fourier-encoded and combined into a unified embedding. Instance captions are encoded using a pre-trained CLIP model. These embeddings are concatenated and processed through an MLP, producing the final layout embedding, which, along with the scene caption embedding, conditions the cross-attention mechanism.

ControlNet-Transformer. Delving into details, the present disclosure introduces ControlNet-Transformer to ensure the precision towards the road sketch control inspired by PixArt-6. Practically, a pre-trained VAE extracts the latent features from road sketches, which are then processed by a 3D patch embedder for the sake of consistency issue with the main network of the present disclosure. To parameterize the design mentioned in the present disclosure, 13 copy blocks are integrated with the first 13 base blocks with the DiT architecture. Each copy block combines the road sketch features and base block outputs, using spatial self-attention to reduce the computational overhead.

Hereinafter, the process of training the generative model will be described.

Variable Resolution and Frame Length. Following OpenSora, the present disclosure adopts the Bucket strategy, which ensures that videos within each batch have consistent resolution and frame length.

Inspired by OpenSora 1.2, the present disclosure replaces Improved Denoising Diffusion Probabilistic Model (IDDPM) with rectified flow during the later training stages for increased stability and reduced inference steps. Rectified flow, an Ordinary Differential Equation (ODE)-based generative model, defines the forward process between data and normal distribution: xₜ=(1−t)x₀+tx₁, where x₁ is a data sample, and x₀ is a sample from the normal distribution. The loss function is constructed as:

$$ℓ ( θ ) := {E}_{{x}_{1} , {x}_{0}} [ {‖ {v}_{θ} ( {x}_{t} , t , c ) - ( {x}_{1} - {x}_{0} ) ‖}_{2}^{2} ] ,$$

with c encompassing the three conditions. Sampling is per-formed from t=1 to t=0 in N steps via

$${x}_{t - \frac{1}{N}} = {x}_{t} - \frac{1}{N} {v}_{θ} ( {x}_{t} , t , c ) , ∀ t ∈ \{ 1 , 2 , … , N \} / N .$$

First-k Frame Masking. To enable arbitrary-length video generation, the present disclosure proposes a first-k frame masking strategy, allowing the model to seamlessly predict future frames from the preceding ones. Formally, given a binary mask m indicating the frames to be masked—where the unmasked frames serve as the condition for future frame generation, the present disclosure updates xₜ as: xₜ←xₜ [symbol] (1−m)+xₜ [symbol] m, with losses calculated only on unmasked frames. During inference, video is generated autoregressively, with the last-k frames of the previous clip conditioning the next.

Classifier-free Guidance for Multi-Conditions. The present disclosure observes that extending classifier-free guidance from the text condition to layout entries and road sketches enhances conditional control precision and visual quality. During training, the present disclosure sets the text condition C_{T}, the layout condition C_{L}, and the sketch condition C_{R} to φ with a 5% probability each, and also enforces a 5% probability where all three conditions are simultaneously set to φ. The guidance scales λ_{T}, λ_{L}, λ_{R} correspond to the scene caption, layout entries, and road sketch, respectively, and measures the alignment between the sampling results and the conditions. Inspired, the modified velocity estimates is as follows:

$${v}_{θ}^{′} = {v}_{θ} ( {x}_{t} , ϕ , ϕ , ϕ ) + {λ}_{T} \cdot ( {v}_{θ} ( {x}_{t} , {C}_{T} , {C}_{L} , {C}_{R} ) - {v}_{θ} ( {x}_{t} , ϕ , {C}_{L} , {C}_{R} ) ) + {λ}_{L} \cdot ( {v}_{θ} ( {x}_{t} , ϕ , {C}_{L} , {C}_{R} ) - {v}_{θ} ( {x}_{t} , ϕ , ϕ , {C}_{R} ) ) + {λ}_{R} \cdot ( {v}_{θ} ( {x}_{t} , ϕ , ϕ , {C}_{R} ) - {v}_{θ} ( {x}_{t} , ϕ , ϕ , ϕ ) ) .$$

The experiment process will be described below.

Dataset and Evaluation metrics. The present disclosure trains and evaluates the model of the present disclosure using the nuScenes dataset and the interpolated 12 Hz annotations provided by the challenge. The generated multi-view videos are assessed based ion distribution similarity (FVD), temporal consistency (DTC and CTC), visual quality (MUSIQ), and controllability. Controllability is evaluated through two perception tasks: 3D object detection and BEV segmentation, with BEVFormer serving as the perception model.

Training Details. The present disclosure trains the method of the present disclosure in four stages using eight NVIDIA A800 GPUs. In the first stage, the present disclosure fine-tunes on OpenSora 1.1 checkpoints with fixed-resolution images of 512×512 for 30 k steps to control layout and sketch, training the ControlNet-Transformer, spatial attention and layout net with spatial self-attention in base blocks. In the second stage, the present disclosure trains the model 26 k steps with variable resolutions (144p, 240p, 360p) and frame lengths to adapt to the nuScenes dataset, continuing to use spatial self-attention. The final two stages replace IDDPM with rectified flow, training for 20 k steps at 144p to 360p, then 80 k steps at higher resolutions (480p to full).

Inference Details. The present disclosure performs sampling inference using rectified flow with 30 steps, choosing 480p resolution for a balance between inference time and visual quality. Each inference round uses a frame length of 16. The present disclosure sets λ_{L} and λ_{R} to 2.0, adjusting λ_{T} to 1.0 for night scenes and 7.0 for other scenes to achieve the best results.

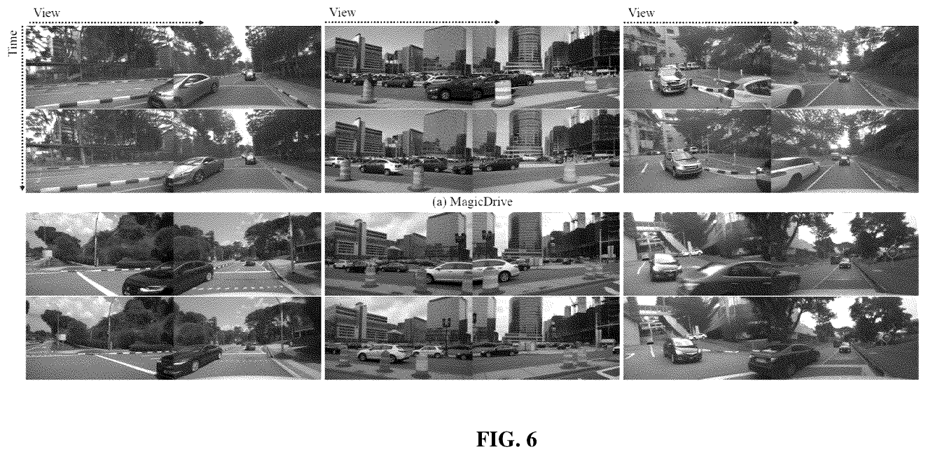

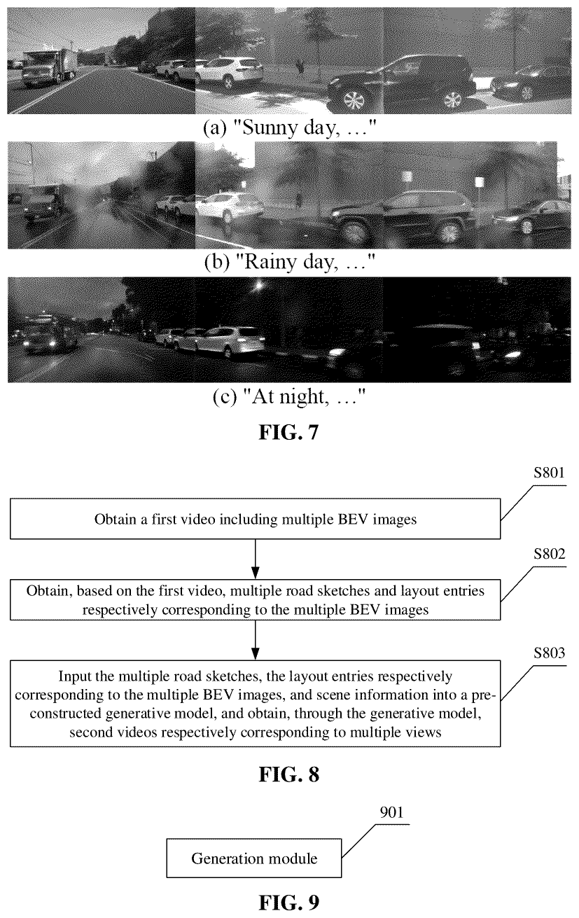

Quality of Controllable Generation. To assess the quality of the generated videos, the present disclosure compares the method with the challenge baseline, MagicDrive, using evaluations on 16-frame sequences. As shown in Table 1, the model of the present disclosure outperforms MagicDrive in terms of data distribution similarity, temporal consistency, visual quality, and controllability. Additionally, FIG. 6 illustrates that the videos produced by the model of the present disclosure exhibit both higher visual quality and better spatial consistency. FIG. 7 demonstrates the scene editing capability of the method of the present disclosure, where the weather in the generated video changes according to the caption, while other objects remain unchanged.

TABLE 1

| Method | FVD_{↓} | Object mAP_{↑} | Map mIoU_{↑} | DTC_{↑} | CTC_{↑} | IQ_{↑} |
|---|---|---|---|---|---|---|
| MagicDrive | 221.90 | 11.73 | 18.44 | 0.8755 | 0.9251 | 48.85 |
| Ours | 94.60 | 24.55 | 35.96 | 0.9132 | 0.9446 | 51.82 |

Table 1 shows quantitative comparison with MagicDrive. DTC, CTC, and IQ represent DINO temporal consistency, CLIP Temporal Consistency, and Imaging Quality, respectively. The best performances are presented in bold.

The ablation study is described below.

Effects of Proposed classifier-free Guidance. The present disclosure compares different classifier-free guidance methods, both with and without unconditional layout and sketch considerations, as detailed in Table 2. The “score” is calculated as in the 1st round of the challenge, with CFG_{T,L,R} being the method proposed in the present disclosure. Excluding unconditional sketches (CFG_{T,L}) or both (CFG_{T}) yielded slightly better FVD but showed more pronounced differences in BEV segmentation and 3D object detection. The present disclosure also evaluated CFG_{MagicDrive} from MagicDrive, which performed well in controllability but had only satisfactory FVD. Ultimately, CFG_{T,L,R} achieved the best overall score.

TABLE 2

| Method | FVD_{↓} | Object mAP_{↑} | Map mIoU_{↑} | score_{↑} |
|---|---|---|---|---|
| CFG_{T, L, R} | 94.60 | 24.55 | 35.96 | 2.5962 |
| CFG_{T, L} | 89.12 | 24.70 | 34.40 | 2.5487 |
| CFG_{T} | 83.63 | 20.05 | 34.26 | 2.1749 |
| CFG_{MagicDrive} | 164.48 | 26.18 | 35.02 | 2.3618 |

In Table 2, ablation on the classifier-free guidance is shown.

The present disclosure proposes the first DiT-based controllable multi-view video generative model tailored for driving scenarios. The integration of ControlNet-Transformer and joint cross-attention facilitates precise control over BEV layouts. Spatial view-inflated attention, combined with a comprehensive set of training and inference strategies, ensures high-quality and consistent video generation. Comparisons with MagicDrive and various visualizations further demonstrate the model's superior control and consistency in generated videos.

FIG. 8 is a schematic flowchart of another implementation manner of a method for generating a multi-view video provided by an embodiment of the present disclosure. As illustrated in FIG. 8, the method for generating a multi-view video provided by an embodiment of the present disclosure may include operations S801 to S803. The operations S801 to S803 will be described in detail below.

In operation S801, the first video including multiple BEV images is obtained.

Exemplarily, the BEV refers to a vertical view. That is, the BEV is an image including the surroundings of the vehicle.

Exemplarily, the multiple BEV images are ordered in time from early to late.

In operation S802, multiple road sketches, and layout entries respectively corresponding to the multiple BEV images are obtained based on the first video.

Exemplarily, one BEV image corresponds to one road sketch.

Exemplarily, one BEV image corresponds to one layout entry. The layout entry of the BEV includes an identifier (ID) of each object in the BEV, an orientation of each object in the BEV, and coordinates of each object in the BEV. Exemplarily, the layout entry of the BEV may further include descriptive information corresponding to each object, for example, a color of the object and a type of the object.

Exemplarily, the type of the object includes, but is not limited to, vehicle, human, or a type of vehicle.

Exemplarily, as illustrated in FIG. 5, the multiple road sketches are represented by Road Sketches, the multiple layout entries are represented by Layout Entries, and the first video is represented by a BEV Layout Sequence.

In operation S803, the multiple road sketches, the layout entries respectively corresponding to the multiple BEV images, and scene information are input into a pre-constructed generative model, and the second videos respectively corresponding to multiple views are obtained through the generative model.

Exemplarily, as illustrated in FIG. 5, the scene information is represented by Scene Caption.

Exemplarily, the scene information includes scene descriptive information respectively corresponding to the multiple BEV images. The scene descriptive information of the BEV images includes information such as the numbers of objects present on the road surface in the BEV images, the types of objects present on the road surface in the BEV images, weather, scenery on both sides of the road, and the like.

It may be understood that in some scenes such as corner scenes in which a large number of videos respectively corresponding to multiple views are difficult to obtain, for example, a scene of a car accident, a car driving into a pond, a car being covered by other objects, the present disclosure can change the scene information and/or layout entries of the BEV images, without changing the multiple road sketches, so that multiple groups of input set can be formed, and each group of input set includes the multiple road sketches, the layout entries respectively corresponding to the multiple BEV images, and the scene information. The layout entries and/or scene information in different input sets are different. Multiple groups of video set can be obtained by inputting different input sets to the generative model, and each group of video set includes the second videos respectively corresponding to the multiple views. Through the above method, a large number of videos respectively corresponding to the multiple views can be obtained based on the same first video.

Hereinafter, the training process of the generative model in the present disclosure will be described with reference to FIG. 5.

Exemplarily, as illustrated in FIG. 5, the encoder (2D Enc), decoder (2D Dec), and T5 labeled “Snowflake”, and Layout Net, do not need to be trained.

Exemplarily, figure (b) on the right side in FIG. 5 is a generative model provided by the present disclosure.

Hereinafter, a process of training the generative model, which includes the following operations A1 to A2, will be described.

In the embodiment of the present disclosure, the first video used for training the generative model is referred to as a sample video. It may be understood that in FIG. 5, the second videos respectively corresponding to the multiple views corresponding to the sample video are represented by “Multi-View Video”. That is, “Multi-View Video” is the annotation result of the sample video.

In operation A1, a multiple road sketches of the sample video, multiple layout entries corresponding to the sample video, scene information corresponding to the sample video, and the annotation result are input into the generative model.

Exemplarily, the pre-trained and frozen variational autoencoder is the 2D Enc in FIG. 5, and the variational autoencoder is from the LDM model.

Exemplarily, the 2D Encs in FIG. 5 may be the same encoder or different encoders.

Exemplarily, the original cross-view attention modules are replaced with parameter-free view-inflated attention mechanism modules in BaseBlock1 to BaseBlock28 illustrated in FIG. 5. The features of B×T×(V H′ W′)×C can be output by the BaseBlock 28. It may be understood that the generative model may be trained with multiple batches of training sets, B is the number of sample videos contained in one batch of training set and C is the number of channels of the image.

Exemplarily, BaseBlock1 to BaseBlock28 (hereinafter referred to as Base Block) also include cross-attention mechanism modules.

Exemplarily, there may be a 3D patch embedder between “2D Enc” and “Zero linear” in FIG. 5, by which spatiotemporal information is modeled.

Exemplarily, in FIG. 5, the outputs of the Layout Net and T5 language model are concatenated through the C module.

Exemplarily, the MLP is part of the Layout Net.

Exemplarily, a Copy Block (i.e., any of Copy Block 1 to Copy Block 13) includes a ControlNet-Transformer.

Exemplarily, the architecture of the Copy Block is the same as the architecture of the Base Block. The Copy Block replicates the architecture of the Base Block.

Exemplarily, the “noise” in FIG. 5 may be added by a rectified flow, or by an IDDPM.

Exemplarily, the rectified flow is an ODE-based generative model. In the formula constructed by the loss function of the rectified flow, x₀ represents the pure noise added by the rectified flow to the sample video.

Exemplarily, the “noise” may be added by IDDPM in the first stage of training the generative model, and the “noise” may be added by the rectified flow in the second stage of training the generative model. After the training of the generative model is completed, the rectified flow is remained to be in the generative model.

Exemplarily, before the annotation result, i.e., “Multi-View Video”, is input to “2D Enc”, a first-k frame masking operation needs to be performed on the annotation result. k is a positive integer greater than or equal to 1. It is assumed that the video corresponding to each view in the annotation result includes multiple images, the masked image will not be added with “noise”, and the unmasked image will be added with “noise”. Accordingly, an unmasked image can be predicted based on the masked image. By this training manner, if the sample video includes 20 BEV images, since the generative model can predict 20−k images, the video corresponding to each view output by the generative model includes 20+(20−k) images.

Exemplarily, before inputting the multiple road sketches of the sample video, multiple layout entries corresponding to the sample video, and the scene information corresponding to the sample video are input to the generative model, the text condition C_{T} (corresponding scene information), the layout condition C_{L} (corresponding layout entry), and the sketch condition C_{R} (corresponding road sketch) need to be set to φ with a certain probability, and in the present application, φ is empty or 0. That is, multiple road sketches are discarded from the sample video with a certain probability, multiple layout entries corresponding to the sample video are discarded with a certain probability, and scene information corresponding to the sample video are discarded with a certain probability

Exemplarily, the probabilities corresponding to the text condition C_{T}, the layout condition C_{L}, and the sketch condition C_{R} may be the same or different.

As an example, if the sample video includes 100 BEV images, 100 road sketches, 100 layout entries, and 100 pieces of scene information can be obtained. If the probability is 5%, 5 road sketches in 100 road sketches can be randomly discarded to remain 95 road sketches, 5 layout entries of 100 layout entries can be randomly discarded to remain 95 layout entries, and 5 pieces of scene information of 100 pieces of scene information can be randomly discarded to remain 95 pieces of scene information.

Exemplarily, the above probability may be determined based on the actual situation, and the present disclosure takes 5% as an example for description. Hereafter, the reference is made to Table 2 to be used for description. In the table 2, CFG_{T,L,R} is the result obtained by the generative model when the probabilities corresponding to the text condition C_{T}, the layout condition C_{L}, and the sketch condition C_{R} are not 0, CFG_{T,L} is the result obtained by the generative model when the probabilities corresponding to the text condition C_{T} and the layout condition C_{L} are not 0 and the probability corresponding to the sketch condition C_{R} is 0, and CFG_{T} is the result obtained by the generative model when the probability corresponding to the text condition C_{T} is not 0 and the probabilities corresponding to the sketch condition C_{R} and the layout condition C_{L} are 0.

In operation A2, the feature output by the Base Block 28 of the generative model is compared with the annotation result to obtain a loss function, and the generative model is obtained by training the loss function.

Hereinafter, a process of using the generative model after the training of the generative model is completed will be described.

Exemplarily, the second videos respectively corresponding to multiple views output by the generative model are obtained by the following formula.

$${v}_{θ}^{′} = {v}_{θ} ( {x}_{t} , ϕ , ϕ , ϕ ) + {λ}_{T} \cdot ( {v}_{θ} ( {x}_{t} , {C}_{T} , {C}_{L} , {C}_{R} ) - {v}_{θ} ( {x}_{t} , ϕ , {C}_{L} , {C}_{R} ) ) + {λ}_{L} \cdot ( {v}_{θ} ( {x}_{t} , ϕ , {C}_{L} , {C}_{R} ) - {v}_{θ} ( {x}_{t} , ϕ , ϕ , {C}_{R} ) ) + {λ}_{R} \cdot ( {v}_{θ} ( {x}_{t} , ϕ , ϕ , {C}_{R} ) - {v}_{θ} ( {x}_{t} , ϕ , ϕ , ϕ ) )$$

Exemplarily, a module including the above calculation formula may be located between BaseBlock28 and 2D Dec in FIG. 5. Exemplarily, the module including the above calculation formula does not require training.

v_{θ}(xₜ, φ, φ, φ) is the result obtained by the generative model when the probabilities corresponding to the text condition C_{T}, the layout condition C_{L}, and the sketch condition C_{R} are not 0. v_{θ}(xₜ, C_{T}, C_{L}, C_{R}) is the result obtained by the generative model when the probabilities corresponding to the text condition C_{T}, the layout condition C_{L} and the sketch condition C_{R} are 0. v_{θ}(xₜ, φ, C_{L}, C_{R}) is the result obtained by the generative model when the probabilities corresponding to the layout condition C_{L} and the sketch condition C_{R} are 0 and the probability corresponding to the text condition C_{T} is not 0. v_{θ}(xₜ, φ, φ, C_{R}) is the result obtained by the generative model when the probability corresponding to the sketch condition C_{R} is 0 and the probabilities corresponding to the text condition C_{T} and the layout condition C_{L} are not 0.

Exemplarily, the module including the above calculation formula inputs v′_{θ} to the 2D Dec in FIG. 5 to obtain the respective second video corresponding to each of the multiple views.

The method for generating a multi-view video provided by an embodiment of the present disclosure has been described above, and an apparatus for performing the above method for generating the multi-view video will be described below.

Referring to FIG. 9, FIG. 9 illustrates a schematic structural diagram of an apparatus for generating a multi-view video according to an embodiment of the present disclosure. As illustrated in FIG. 9, the apparatus for generating a multi-view video includes a generation module.

The generation module 901 is configured to generate, through a generative model, at least one image with at least one view by using at least one BEV.

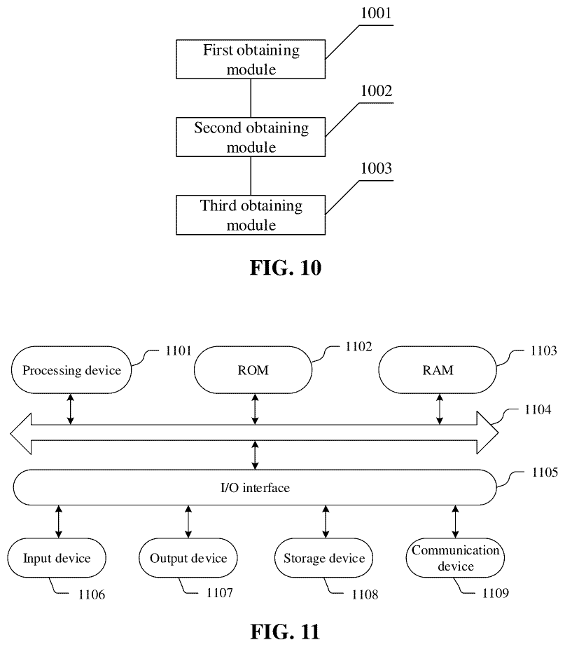

Referring to FIG. 10, FIG. 10 illustrates a schematic structural diagram of another implementation manner of the apparatus for generating a multi-view video according to an embodiment of the present disclosure. As illustrated in FIG. 10, the apparatus for generating a multi-view video includes the first obtaining module 1001, the second obtaining module 1002 and the third obtaining module 1003.

The first obtaining module 1001 is configured to obtain the first video including multiple BEV images.

The second obtaining module 1002 is configured to obtain, based on the first video, multiple road sketches, and layout entries respectively corresponding to the multiple BEV images.

The third obtaining module 1003 is configured to input the multiple road sketches, the layout entries respectively corresponding to the multiple BEV images, and scene information into a pre-constructed generative model, and to obtain, through the generative model, the second videos respectively corresponding to the multiple views.

The embodiments of the present disclosure further provide an electronic device. Referring to FIG. 11, a schematic structural diagram suitable for implementing an electronic device in the embodiment of the present disclosure is illustrated. The electronic device in the embodiment of the present disclosure may include, but is not limited to, a fixed terminal such as a mobile phone, a notebook computer, a Personal Digital Assistant (PDA), a Tablet Computer (PAD), a desktop computer, and the like. The electronic device illustrated in FIG. 11 is merely an example, and should not impose any limitation on the functions and scope of use of the embodiments of the present disclosure.

As illustrated in FIG. 11, the electronic device may include a processing device (such as a central processing unit, a graphics processor, or the like) 1101 that may perform various appropriate actions and processes according to a program stored in a Read-Only Memory (ROM) 1102 or a program loaded from a storage device 1108 into a Random Access Memory (RAM) 1103. In a state in which the electronic device is powered on, various programs and data necessary for the operation of the electronic device are also stored in the RAM 1103. The processing device 1101, the ROM 1102, and the RAM 1103 are connected to each other via a bus 1104. An input/output (I/O) interface 1105 is also connected to the bus 1104.

Generally, the following devices may be connected to the I/O interface 1105: an input device 1106 including, for example, a touch screen, a touch pad, a keyboard, a mouse, a camera, a microphone, an accelerometer, a gyroscope, and the like, an output device 1107 including, for example, a liquid crystal display (LCD), a speaker, a vibrator, and the like, a storage device 1108 including, for example, a memory card, a hard disk, or the like, and a communication device 1109. The communication device 1109 may allow an electronic device to communicate wirelessly or wired with other devices to exchange data. Although FIG. 11 illustrates an electronic device with various devices, it should be understood that it is not required that all of the illustrated devices are implemented or provided. More or fewer devices may alternatively be implemented or provided.

The embodiments of the present disclosure further provide a computer program product, which includes computer readable instructions. When the computer readable instructions are run on the electronic device, the electronic device implements any one of the methods for generating a multi-view video provided by the embodiments of the present disclosure.

The embodiments of the present disclosure further provide a computer readable storage medium. The storage medium carries one or more computer programs, and when the one or more computer programs are executed by the electronic device, the electronic device can implement any one of the methods for generating a multi-view video provided by the embodiments of the present disclosure.

In addition, it should be noted that the apparatus embodiments described above are merely schematic. The units described as separate components may or may not be physically separated, and the components displayed as units may or may not be physical units, that is, they may be located in one place or may be distributed to multiple network units. Some or all of the modules may be selected according to actual needs to achieve the purpose of the solution of this embodiment. In addition, in the drawings of the embodiments of the apparatus provided in the present disclosure, the connection relationship between modules indicates that there is a communication connection between them, and specifically, it may be implemented as one or more communication buses or signal lines.

From the above description of the embodiments, those skilled in the art can clearly understand that the present disclosure can be implemented by software and necessary general hardware, and of course, it can also be implemented by special hardware including application specific integrated circuits, special CPUs, special memories, special components, and the like. In general, all functions completed by computer programs can be easily realized by corresponding hardware, and the specific hardware structures used to realize the same function can also be various, such as analog circuits, digital circuits, or special circuits. However, more often than not, software program implementation is a preferred embodiment for the purpose of the present disclosure. Based on this understanding, the technical solution of the present disclosure in essence or in part contributing to the prior art can be embodied in the form of a software product, which is stored in a readable storage medium, such as a floppy disk, a U disk, a mobile hard disk, a ROM, a RAM, a magnetic disk or an optical disk of a computer, etc., and includes several instructions for causing a computer device (which may be a personal computer, a training device, or a network device, etc.) to perform the methods described in various embodiments of the present disclosure.

In the embodiments described above, it may be implemented in whole or in part by software, hardware, firmware, or any combination thereof. When implemented using software, it may be implemented in whole or in part in the form of a computer program product.

The computer program product includes one or more computer instructions. When the computer program instructions are loaded and executed on a computer, the processes or functions described in accordance with embodiments of the present disclosure are generated in whole or in part. The computer may be a general purpose computer, a special purpose computer, a computer network, or other programmable device. The computer instructions may be stored in a computer readable storage medium, or transferred from one computer readable storage medium to another computer readable storage medium. For example, the computer instructions may be transmitted from one website site, computer, training device or data center to another website site, computer, training device or data center by wired (e.g., coaxial cable, fiber optic, digital subscriber line (DSL)) or wireless (e.g., infrared, wireless, microwave, etc.) means. The computer readable storage medium may be any available medium that can store in a computer or a data storage device such as a training device, a data center, or the like that includes one or more available media integrations. The available medium may be a magnetic medium (e.g., a floppy disk, a hard disk, a magnetic tape), an optical medium (e.g., a DVD), or a semiconductor medium (e.g., a Solid State Disk (SSD)), or the like.

1. A method for generating a multi-view video, comprising:
generating, through a generative model, at least one image with at least one view by using at least one Bird's Eye View (BEV) image.

2. The method for generating a multi-view video of claim 1, wherein generating, through the generative model, at least one image with at least one view by using at least one BEV image comprises:
obtaining a first video comprising a plurality of BEV images;
obtaining, based on the first video, a plurality of road sketches, and layout entries respectively corresponding to the plurality of BEV images; and
inputting the plurality of road sketches, the layout entries respectively corresponding to the plurality of the BEV images, and scene information into a pre-constructed generative model, and obtaining, through the generative model, second videos respectively corresponding to a plurality of views.

3. The method for generating the multi-view video of claim 2, wherein obtaining, based on the first video, the plurality of road sketches, and the layout entries respectively corresponding to the plurality of BEV images comprises:
obtaining, based on the first video, the plurality of road sketches; and
changing at least one layout entry among the layout entries respectively corresponding to the plurality of BEV images.

4. The method for generating the multi-view video of claim 2, wherein inputting the plurality of road sketches, the layout entries respectively corresponding to the plurality of the BEV images, and the scene information into the pre-constructed generative model, and obtaining, through the generative model, the second videos respectively corresponding to the plurality of views comprise:
obtaining the scene information corresponding to the first video;
changing the scene information; and
inputting the plurality of road sketches, the layout entries respectively corresponding to the plurality of the BEV images, and changed scene information into the pre-constructed generative model, and obtaining, through the generative model, the second videos respectively corresponding to the plurality of views.

5. The method for generating the multi-view video of claim 2, wherein the method for training the generative model comprises:
obtaining sample videos;
obtaining road sketches respectively corresponding to a plurality of BEV images in each sample video and layout entries respectively corresponding to the plurality of BEV images in the sample video;
inputting the road sketches respectively corresponding to the plurality of BEV images in the sample video, the layout entries respectively corresponding to the plurality of BEV images in the sample video, scene information corresponding to the sample video, and an annotation result of the sample video into the generative model to obtain an output feature of the generative model; and
training the generative model based on the output feature and the annotation result.

6. The method for generating the multi-view video of claim 5, wherein no noise is added to first k images in the annotation result, and noise is added to images, other than the first k images, in the annotation result, and
a second video comprises a first number of images, the first number being a sum of a second number and a result of subtracting k from the second number, and the second number being a number of images comprised in the first video.

7. The method for generating the multi-view video of claim 6, wherein the noise is added by Improved Denoising Diffusion Probabilistic Model (IDDPM) in a first stage of training the generative model, or the noise is added by a rectified flow in a second stage of training the generative model.

8. An apparatus for generating a multi-view video, comprising a processor and a memory connected with the processor, wherein
the memory is configured to store a computer program; and
the processor is configured to execute the computer program to cause the apparatus to:
generate, through a generative model, at least one image with at least one view by using at least one Bird's Eye View (BEV) image.

9. The apparatus for generating a multi-view video of claim 8, wherein the processor is specifically configured to:
obtain a first video comprising a plurality of BEV images;
obtain, based on the first video, a plurality of road sketches, and layout entries respectively corresponding to the plurality of BEV images; and
input the plurality of road sketches, the layout entries respectively corresponding to the plurality of the BEV images, and scene information into a pre-constructed generative model, and obtain, through the generative model, second videos respectively corresponding to a plurality of views.

10. The apparatus for generating the multi-view video of claim 9, wherein when obtaining, based on the first video, the plurality of road sketches, and the layout entries respectively corresponding to the plurality of BEV images, the processor is configured to cause the apparatus to:
obtain, based on the first video, the plurality of road sketches; and
change at least one layout entry among the layout entries respectively corresponding to the plurality of BEV images.

11. The apparatus for generating the multi-view video of claim 9, wherein when inputting the plurality of road sketches, the layout entries respectively corresponding to the plurality of the BEV images, and the scene information into the pre-constructed generative model, and obtaining, through the generative model, the second videos respectively corresponding to the plurality of views, the processor is configured to cause the apparatus to:
obtain the scene information corresponding to the first video;
change the scene information; and
input the plurality of road sketches, the layout entries respectively corresponding to the plurality of the BEV images, and changed scene information into the pre-constructed generative model, and obtain, through the generative model, the second videos respectively corresponding to the plurality of views.

12. The apparatus for generating the multi-view video of claim 9, wherein the generative model is trained by:
obtaining sample videos;
obtaining road sketches respectively corresponding to a plurality of BEV images in each sample video and layout entries respectively corresponding to the plurality of BEV images in the sample video;
inputting the road sketches respectively corresponding to the plurality of BEV images in the sample video, the layout entries respectively corresponding to the plurality of BEV images in the sample video, scene information corresponding to the sample video, and an annotation result of the sample video into the generative model to obtain an output feature of the generative model; and
training the generative model based on the output feature and the annotation result.

13. The apparatus for generating the multi-view video of claim 12, wherein no noise is added to first k images in the annotation result, and noise is added to images, other than the first k images, in the annotation result, and
a second video comprises a first number of images, the first number being a sum of a second number and a result of subtracting k from the second number, and the second number being a number of images comprised in the first video.

14. The apparatus for generating the multi-view video of claim 13, wherein the noise is added by Improved Denoising Diffusion Probabilistic Model (IDDPM) in a first stage of training the generative model, or the noise is added by a rectified flow in a second stage of training the generative model.

15. A computer storage medium carrying one or more computer programs that, when executed by an electronic device, cause the electronic device to:
generate, through a generative model, at least one image with at least one view by using at least one Bird's Eye View (BEV) image.

16. The computer storage medium of claim 15, wherein generating, through the generative model, at least one image with at least one view by using at least one BEV image comprises:
obtaining a first video comprising a plurality of BEV images;
obtaining, based on the first video, a plurality of road sketches, and layout entries respectively corresponding to the plurality of BEV images; and
inputting the plurality of road sketches, the layout entries respectively corresponding to the plurality of the BEV images, and scene information into a pre-constructed generative model, and obtaining, through the generative model, second videos respectively corresponding to a plurality of views.

17. The computer storage medium of claim 16, wherein obtaining, based on the first video, the plurality of road sketches, and the layout entries respectively corresponding to the plurality of BEV images comprises:
obtaining, based on the first video, the plurality of road sketches; and
changing at least one layout entry among the layout entries respectively corresponding to the plurality of BEV images.

18. The computer storage medium of claim 16, wherein inputting the plurality of road sketches, the layout entries respectively corresponding to the plurality of the BEV images, and the scene information into the pre-constructed generative model, and obtaining, through the generative model, the second videos respectively corresponding to the plurality of views comprise:
obtaining the scene information corresponding to the first video;
changing the scene information; and
inputting the plurality of road sketches, the layout entries respectively corresponding to the plurality of the BEV images, and changed scene information into the pre-constructed generative model, and obtaining, through the generative model, the second videos respectively corresponding to the plurality of views.

19. The computer storage medium of claim 16, wherein the generative model is trained by:
obtaining sample videos;
obtaining road sketches respectively corresponding to a plurality of BEV images in each sample video and layout entries respectively corresponding to the plurality of BEV images in the sample video;
inputting the road sketches respectively corresponding to the plurality of BEV images in the sample video, the layout entries respectively corresponding to the plurality of BEV images in the sample video, scene information corresponding to the sample video, and an annotation result of the sample video into the generative model to obtain an output feature of the generative model; and
training the generative model based on the output feature and the annotation result.

20. The computer storage medium of claim 19, wherein no noise is added to first k images in the annotation result, and noise is added to images, other than the first k images, in the annotation result, and
a second video comprises a first number of images, the first number being a sum of a second number and a result of subtracting k from the second number, and the second number being a number of images comprised in the first video.
